(19) United States
(12) Patent Application Publication
(10) Pub. No.: US 2011/0215077 A1
(43) Pub. Date: Sep. 8, 2011

(54) WATER DRAIN TOOL

(75) Inventors: Mark SMILES, Kinsham (GB); Patrick SANDIFORD, Chepstow Monmoughshire (GB)

(73) Assignee: AIRBUS OPERATIONS LIMITED, Bristol (GB)

(21) Appl. No.: 13/029,227

(22) Filed: Feb. 17, 2011

(30) Foreign Application Priority Data
Mar. 4, 2010 (GB) 1003614.3

(51) Int. Cl. H05B 1/00

(52) U.S. Cl. 219/201

(57) ABSTRACT

A water drain tool for opening a water drain valve of an aircraft fuel tank, the tool comprising a probe and a heat source, wherein the probe is adapted to engage the valve in order to open it and the heat source is adapted to direct heat towards the valve when the valve is being opened. The valve is heated with the probe in order to melt ice formed within the valve which may otherwise impede its normal operation.

### FIELD OF THE INVENTION

The present invention relates to a water drain tool for opening a water drain valve of an aircraft fuel tank and a method of opening a water drain valve of an aircraft fuel tank.

### BACKGROUND OF THE INVENTION

Water contamination in aircraft fuel tanks can be potentially troublesome in aircraft fuel systems. Measures are therefore taken to remove as much water as possible from the fuel tank before take-off. A conventional method for draining water from fuel tanks involves providing water drain valves on the bottom wall of the fuel tank. To prevent an accumulation of water in the fuel tank, water is drained by manually opening these valves as a regular, scheduled maintenance task. However, there are problems associated with this method. In particular, as the aircraft reaches altitude, the ambient temperature drops to around −50° C. which converts the water to ice. This also applies to water which can enter the drain valves and build up in the surrounding area of the tank. When this water freezes, a build up of ice can make the valves stiff to operate or even jam the valves completely. Depending on the ambient temperature at ground level, the ice in and around the valve can often fail to thaw in time for the water drain maintenance task to be accomplished in a normal aircraft turn around. This can cause delays for passengers and be expensive for airlines.

Another problem is that, if the water drain maintenance task is performed when the ground ambient temperature is low, ice formed in and around the valves can cause them to temporarily jam in their open position.

One solution to this problem is to tow the aircraft to a heated hanger to carry out the maintenance task. There, the ice can melt and the valves are free to open. However, this is a very expensive option and can still put the aircraft out of use for a significant amount of time. Alternatively, the airline's schedule can be planned so that each aircraft visits locations with sufficiently high ambient temperatures to enable the ice to melt and the maintenance task to be performed. However, this can be extremely inconvenient to the airline and is often not possible. Other solutions include refuelling with warm fuel and pumping it around the tanks for a sustained period to melt the ice around the valves. However, this is again time consuming and expensive.

Therefore, a new, quick and efficient method of melting ice formed in and around water drain valves is required which will enable water to be drained from the valves even when the ambient temperature on the ground is low.

### SUMMARY OF THE INVENTION

A first aspect of the invention provides a water drain tool for opening a water drain valve of an aircraft fuel tank, the tool comprising a probe and a heat source, wherein the probe is adapted to engage the valve in order to open it and the heat source is adapted to direct heat towards the valve when the valve is being opened.

A second aspect of the invention provides a method of opening a water drain valve of an aircraft fuel tank using a water drain tool, the tool comprising a probe and a heat source, the method comprising: engaging the valve with the probe; and directing heat towards the valve from the heat source.

The water drain tool may comprise a probe and a heat source only. Alternatively, the water drain tool may further comprise a funnel. In this case, the probe is preferably disposed with the funnel. The tool may or may not be supplied with a container for collecting fluid.

As described in the Background of Invention, ice formed within a water drain valve can make it stiff to operate or even jam it completely. Moreover, the ice can often fail to thaw when the aircraft is grounded due to low ambient temperatures. Due to aircraft regulations, it is not possible to incorporate a heat source within the valve itself. The heat source of the water drain tool provides a solution to this problem. That is, the heat source can be used to direct heat towards the valve when the valve is being opened. This supply of directed heat helps to melt the ice, thus allowing the water drain valves to be opened and closed without significant interference from ice, even in low ambient temperatures.

In a preferred embodiment of the first aspect of the invention, the heat source is housed within the probe. The heat source may additionally or alternatively be housed within the funnel. The heat source may additionally or alternatively comprise a removable heated collar.

In one embodiment, the heat source comprises an electrically resistive heating element. Such a heating element may be embedded within the probe. Such a heating element may also be embedded within the funnel and/or the removable collar. The tool may optionally further comprise an air blower to aid the heat transfer process from the heat source to the valve.

Optionally, the heat source comprises a thermal fuse in order to limit its maximum temperature. This is a failsafe feature which helps to remove any ignition risk.

Preferably, the tool includes a battery power source. This may be used to power the heat source or only part of the heat source.

Optionally, the water drain tool of the first aspect of the invention further comprises a vibrating means for vibrating the probe, while the method of the second aspect of the invention may further comprise vibrating the probe. In this case, the vibration is transmitted from the probe to the valve in order break up the ice formed within the valve. This increases the exposed surface area of the ice and speeds up the melting process.

Preferably, the water drain tool comprises a container for collecting fluid which is drained from the tank using the tool. In this case, the method of the second aspect of the invention further comprises draining fluid from the fuel tank and collecting the fluid in the container. This prevents spillage and allows samples of the fluid drained from the tank to be collected for analysis.

The method of opening a water drain valve of an aircraft fuel tank according to the second aspect of the invention may further comprise applying pressure to the probe in order to open the valve. In this case, the method may further comprise lifting a poppet of the valve with the probe in order to open the valve.

As described above, it is preferable that the probe comprises an embedded heating element. In this case, the method of the second aspect of the invention further comprises directing heat towards the valve through the probe.

Preferably, the method further comprises draining fluid from the tank and collecting it in a container. The container may be any shape or size. For example but not exclusively the container may be a bottle or a tanker.

Preferably, the water drain tool employed in the method of the second aspect of the invention comprises the water drain tool of the first aspect of the invention.

### BRIEF DESCRIPTION OF THE DRAWINGS

Embodiments of the invention will now be described with reference to the accompanying drawings, in which:

FIG. 1 is a front on view of an aircraft;

FIG. 2 is a schematic view of a fuel tank which is housed within one of the wings of the aircraft of FIG. 1;

FIG. 3a is an exploded view of an indirect water drain valve;

FIG. 3b is a section view of the water drain valve of FIG. 3a;

FIG. 3c is an exploded view of a direct water drain valve;

FIGS. 4a and 4b are schematic and plan views of a water drain tool of the prior art for opening the water drain valves of FIGS. 2a-2c;

FIG. 4c is a schematic view of an alternative water drain tool of the prior art for opening the water drain valve of FIGS. 2a-2c;

FIGS. 5a and 5b are schematic and plan views of a water drain tool according to a first embodiment of the invention;

FIGS. 6a and 6b are schematic views of a water drain tool according to a second embodiment of the invention; and

FIG. 7 is a schematic view of a water drain tool according to a third embodiment of the invention.

### DETAILED DESCRIPTION OF EMBODIMENT(S)

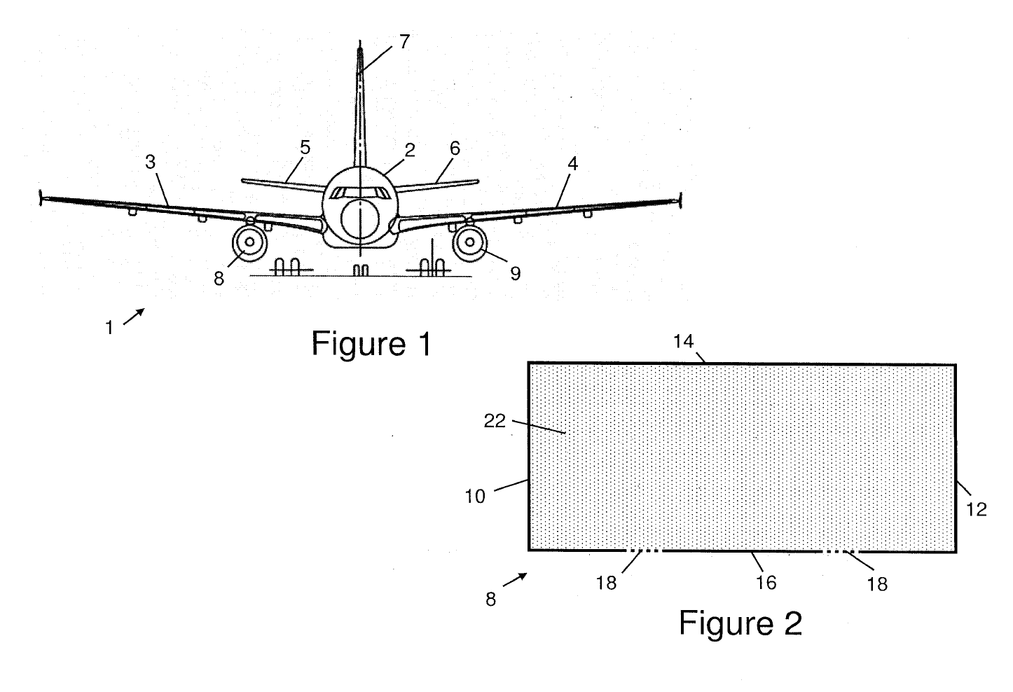

Referring to FIG. 1, an aircraft 1 comprises a fuselage 2 carrying a pair of wings 3, 4, a pair of horizontal stabilisers 5, 6 and a vertical stabiliser 7. Each wing 3, 4 carries an engine 8, 9. Fuel for each engine is stored in a centre tank within the fuselage 2, in one or more wing tanks within the wings 3, 4 and optionally in tanks within the horizontal stabilisers 5, 6. The description below refers to one of the wing tanks but could equally refer to the centre tank, any additional wing tanks or the tanks within the horizontal stabilisers 5, 6.

FIG. 2 is a schematic illustration of a wing tank 8 which comprises front and rear spars 10, 12 and upper and lower covers 14, 16 which are attached to, and extend between, the spars 10, 12. A pair of ribs (not shown) provide the span-wise boundaries of the tank 8. The wing tank 8 also comprises a pair of water drain valves 18 which are fitted into corresponding holes in the lower cover 16. The wing tank 8 is filled with fuel 22 which is contaminated with water. As the water is more dense than the fuel, the water sinks to the bottom of the tank 8 to form a sump at the lowest point(s) in the tank.

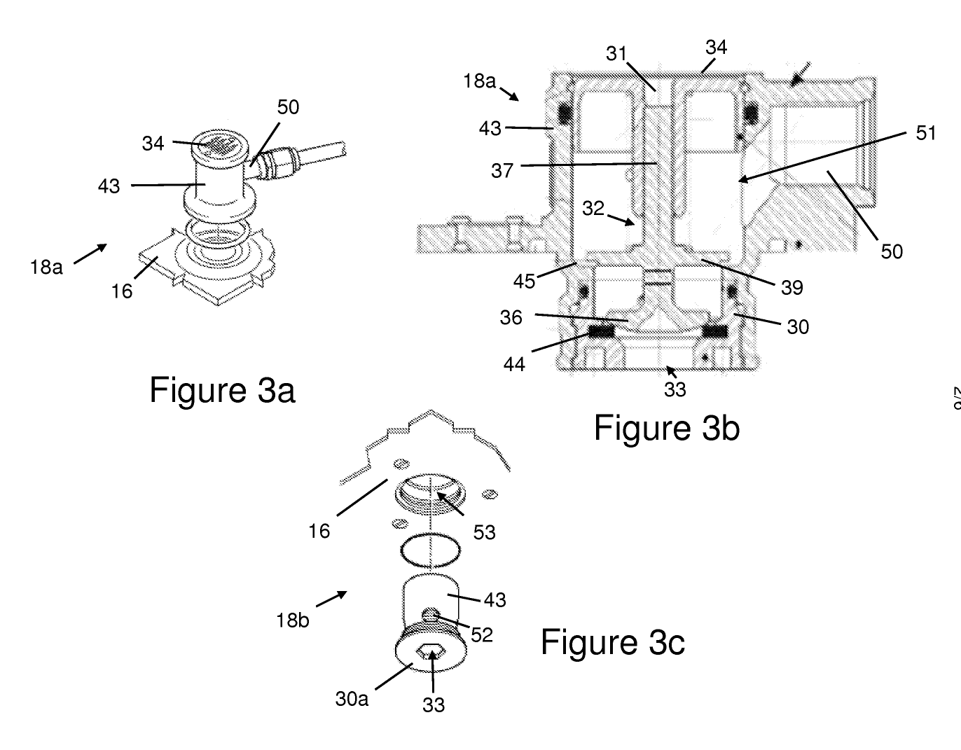

The water drain valves 18 may be direct or indirect valves. FIGS. 3a and 3b are exploded and sectional views of an indirect water drain valve 18a. The indirect water drain valve 18a is designed to be located at a position on the lower cover 16 where the water sump tends not to collect. This type of valve can be required where it is not possible (for example, when forming a hole at a particular position on the lower cover may compromise structural requirements) to form a hole in the lower cover 16 for the installation of a direct water drain valve at the lowest point in the tank where the water accumulates.

The indirect water drain valve 18a comprises an outer valve cap 30 and a valve body 43. The outer perimeter of the valve cap 30 and the inner perimeter of the base of the valve body 43 are threaded to allow the cap 30 to be screwed into the valve body 43. The valve body 43 houses a slidable poppet 32 and an inner channel 31, the top of which is sealed by a plate 34. The slidable poppet 32 has a head 36 and a shaft 37 which extends upwards from the head 36 into the channel 31. A disc 39 extends radially from the shaft 37 at a position between the opening of the channel 31 and the head 36. A spring (not shown) is coiled around the outer perimeter of the channel 31 and extends between the disc 39 and the top of the valve body 43. The outer valve cap 30 has a hole 33 (see FIG. 3b) through its centre which acts as the outlet of the valve 18a (see below).

When the valve 18a is in its closed position (as shown in FIG. 3b), the head 36 of the poppet 32 engages a seal 44 which is formed on the internal surface of the outer valve cap 30, while the disc 39 engages an inner rim 45 of the valve body 43. In this position, the spring is partially compressed between the disc 39 and the top of the valve body 43. The expansion force exerted by the spring on the disc 39 biases the poppet 32 towards the seal 44. The interactions between the head 36 of the poppet 32 and the seal 44, and between the disc 39 and the rim 45, form water tight seals around the hole/outlet 33. The biasing force of the spring thus provides the valve 18a with a default closed position. The cap 30 and the seal 44 can be easily removed by unscrewing the cap 30. This allows a replacement cap 30 (and seal 44) to be installed.

A pipe 50 extends between an area of the fuel tank where the water sump tends to collect and an opening 51 in the side of the valve 18a. When the tank is full, the pressure provided by the fuel head above the water sump drives the water into the pipe 50 towards the valve 18a. Note that the indirect valve 18a cannot be used to its full effect (if at all) when the tank contains little or no fuel as there is no fuel head pressure to force the water through the pipe 50.

FIG. 3c shows a direct water drain valve 18b. The direct water drain valve 18b is similar to the indirect water drain valve 18a and identical features are given the same reference numerals. The direct water drain valve 18b is designed to be located at a position on the lower cover where the water sump tends to collect. Therefore, the pipe 50 is omitted and fluid can flow directly into the valve 18b through an opening 52 on the side of the valve body 43. Note that the valve cap 30a is integrally formed with the valve body 43 and that the outer perimeter of the valve cap 30a is threaded. The inner perimeter of the hole 53 in the cover 16 which surrounds the valve is also threaded to allow the cap 30a to be screwed into the cover 16.

For the purposes of the description below, it will be understood that references to water drain valve 18 are to be construed as references to either the direct or indirect water drain valves 18a, 18b described above.

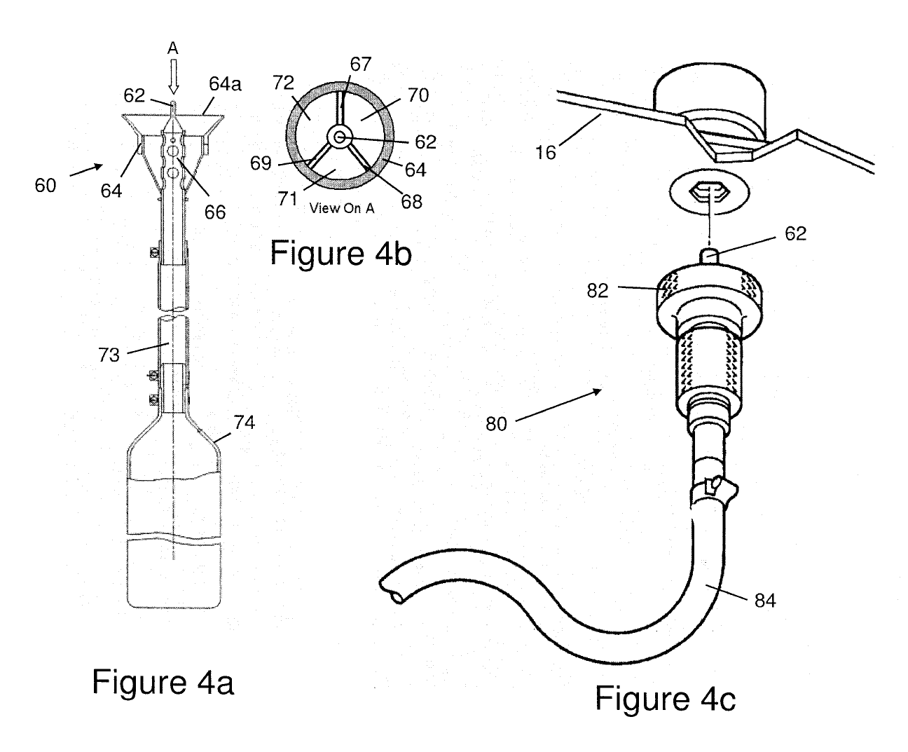

FIG. 4a is a schematic sectional view of a water drain tool 60 of the prior art which can be used to open the water drain valves 18 to drain water (and/or fuel) from the wing tank 8. The water drain tool 60 comprises a cylindrical probe 62 disposed within a conical funnel 64 which forms a closed perimeter around the probe 62. The probe 62 is attached to (or is integrally formed with) a shaft 66 which is mounted to the inside of the funnel 64 by flanges 67-69. This is shown in the plan view of FIG. 4b. The flanges 67-69 are sized to leave gaps 70-72 between the shaft 66 and the funnel 64 through which fluid can flow. The base of the funnel 64 is attached to the neck 73 of a bottle 74. Note that the tool 60 may be provided with or without the bottle 74.

In order to open the valve, the water drain tool 60 is manually lifted into position underneath the water drain valve 18. The tip of the probe 62, which extends beyond the lip 64a of the funnel 64, is inserted into the hole 33 in the outer valve cap 30 to engage the head 36 of the poppet 32 An upwards pressure is applied to the tool in order to lift the poppet 32 with the probe 62 against the biasing force of the spring. When the poppet 32 is lifted, the spring is further compressed between the disc 39 and the top of the valve body 43. Moreover, the head 36 of the poppet 32 is disengaged from the seal 44 and the disc 39 is disengaged from the rim 45, while the shaft 37 penetrates deeper into the channel 31. This allows fluid to drain out of the tank 8 under gravity through the open valve 18 and the hole/outlet 33 in the outer valve cap 30.

As the tool 60 is moved upwards, the lip 64a of the funnel 64 engages the external surface of the lower cover 16. The funnel 64, which is flexible to enable it to bend against the lower cover 16 in response to further upwards pressure applied to the tool, helps to direct the fluid down into the bottle 74 through the gaps 70-72 and the neck 73.

Preferably, the probe 62 is retractable to allow the funnel 64 to engage the lower cover 16 before the valve 18 is opened. In this case, a partially compressed spring biases the probe 62 in an extended position. The biasing force exerted on the probe 62 is less than that exerted by the valve spring on the poppet 32. Therefore, when an upwards pressure is applied to the probe 62 against the poppet 32, the probe 62 retracts until the lip 64a of the funnel 64 engages the cover 16, while the valve 18 remains closed. The probe 62 is configured such that, when the funnel 64 engages the cover 16, the probe is fully retracted and the spring is fully compressed. Further upwards pressure lifts the poppet 32 and opens the valve 18. As the funnel 64 has already engaged the cover 16, spillage of fluid exiting the valve 18 is prevented.

As well as being used to drain water from the tank 8, the tool 60 may also be used to drain fuel from the tank. This allows the tank 8 to be emptied as part of the pre-entry procedure which allows engineers to enter the tank 8 to perform maintenance tasks.

FIG. 4c shows an alternative water drain tool 80, again of the prior art. This tool is similar to the tool 60 of FIG. 4a and the same reference numerals will be used for identical features. The tool 80 comprises a cylindrical funnel 82 rather than a conical funnel. Additionally, the tool 80 is coupled to a hose 84 which leads to a separate storage container (not shown) such as a tanker. To open the valve 18, the probe 62 is used to lift the poppet of the valve 18 as before and the funnel 82 directs the drained fluid through the hose 84 into the storage container. Optionally, the separate storage container may comprise a suction pump in order to suck fluid from the tank 8 through the hose 84 into the container.

In both of the above water drain tools 60 and 80, the probe 62 and the poppet 32 may be adapted to form a bayonet-type fitting to enable the tool 60, 80 to be coupled to the valve during use. In this case, a spring (not shown) is mounted to the tip of the probe 62 so that it engages the poppet 32. Additionally, the distal end of the probe 62 has a pair of pins extending from its side, while the head 36 of the poppet 32 has a corresponding pair of L-shaped slots. When the tool 60, 80 is in use, the spring is compressed against the head 36 of the poppet 32. Meanwhile, the pins are inserted into the L-shaped slots and the tool 60, 80 is rotated to secure the pins within the slots and thus couple the tool 60, 80 to the valve 18. This ensures that the tool 60, 80 remains attached to the poppet when the tank 8 is being drained. After use, the tool 60, 80 is rotated in the opposite direction and pulled downwards in order to remove the pins from the slots and decouple the tool 60, 80 from the valve 18.

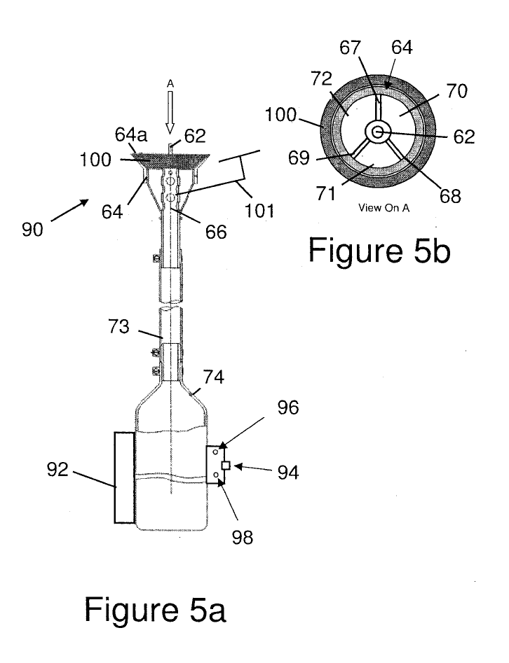

FIG. 5a shows a water drain tool 90 according to a first embodiment of the invention. The water drain tool 90 has a number of features in common with the water drain tool 60 described above and identical features will be given the same reference numerals. As well as retaining the features of the water drain tool 60, the water drain tool 90 comprises a rechargeable battery pack 92 which is electrically connected to an on/off switch 94, a charge indicator 96 and an on/off indicator 98. The battery pack 92, switch 94 and indicators 96, 98 are mounted to the bottle 74. The on/off switch 94 controls the flow of electrical current from the battery pack 92, while the on/off indicator indicates whether the switch is on or off. The charge indicator 96 provides an indication of the quantity of electrical charge remaining in the battery pack 92. The tool 90 further comprises a removable collar 100 which is wrapped around the outer diameter of the funnel 64. This is illustrated in FIG. 5b which is a plan view of the tool 60 taken along arrow A indicated in FIG. 5a. The removable collar 100 is secured to the funnel by cable ties (not shown) wrapped around its outer perimeter. However, it will be understood that any other suitable mechanism, such as a velcro strap or an elastic strap/buckle arrangement, could be used. Electrically resistive heating elements, which are also electrically connected to the battery pack 92, are embedded within the probe 62 and the removable collar 100. When the battery pack 92 is switched on, the heating elements are activated, causing both the probe 62 and the collar 100 to heat up.

As indicated in the Background of Invention, free water within the water drain valves 18 freezes when the aircraft reaches altitude and, additionally, at ground level in low ambient temperatures. A build up of ice can make the valves stiff to operate or even jam the valves completely. In the valve design described above, this can be a particular problem if ice crystals form between the head 36 of the poppet 32 and the disc 39 and/or in the region between the disc 39 and the top of the valve body 43 as the ice crystals can prevent the valve from being opened. Moreover, these ice crystals can jam the valves in their open positions, which can potentially lead to fuel leakage. If the ground ambient temperature is sufficiently low, the ice in and around the valve can often fail to thaw in time for the water drain maintenance task to be accomplished in a normal aircraft turn around (if at all).

It is not possible to incorporate heating means within the valves themselves due to constraints imposed by aircraft regulations. However, the water drain tool 90 described above can be used to overcome this problem. Before engaging the probe 62 with the water drain valve 18 (or as it is engaged), the battery pack 92 is switched on to heat both the probe 62 and the collar 100. When the probe 62 engages the poppet 32, heat is directed through the probe 62 towards the poppet 32 in order to melt any ice crystals which have formed within the valve 18. The heated collar 100 also heats the area around the valve 18. Heating the poppet 32 and the surrounding area helps to melt the ice, thus allowing the poppet to be lifted and the valve to be opened. It is also noted that, by removing ice from the valve, it will be prevented from jamming in the open position, even when the ground ambient temperature is low. Melting ice surrounding the valve increases the volume of water that can be drained from the tank 8 during each maintenance task.

As indicated above, the tip of the probe 62 typically extends beyond the lip 64a of the funnel 64 (and therefore beyond the lip of the heated collar 100). When a build up of ice in the valve 18 prevents the poppet 32 from being raised, this arrangement can prevent the heated collar 100 from fully engaging the lower cover 16. Therefore, the probe 62 is preferably retractable (see above) so that, when an upwards force is applied to the poppet 32, it retracts until it is flush with the lip of the heated collar 100. This allows the heated collar 100 to engage the lower cover 16 even when the valve 18 is jammed shut. This helps to maximise heat transfer from the collar 100 to the lower cover 16, thereby enabling the ice to be melted more quickly. As an alternative to making the probe retractable, a fixed probe 62 may be configured so that its tip is flush with the lip 64a of the funnel 64 (and therefore with the lip of the heated collar 100). In this case, the collar 100 will engage the lower cover 16 at the same time as the tip of the probe 62 when the tool is in use. In both cases, the collar 100 and the funnel 64 are sufficiently flexible to enable them to bend against the lower cover 16 when the poppet 32 is lifted and the probe 62 is inserted into the valve.

The removable collar 100 may be made from a flexible material such as elastomer. Alternatively, the removable collar 100 may be made from a heat conductive material, such as a metallic element or compound. In this case, the collar 100 transmits heat more efficiently to the lower cover 16 to help melt any ice formed around the valves 18. Moreover, the heating elements may be provided with different settings and heat control switches. This enables the temperature of the heating elements to be adjusted depending on the ambient temperature. Optionally, the removable collar 100 may be omitted, leaving the funnel 64 unheated. In this case, heating the probe 62 alone is sufficient to remove the necessary quantity of ice from the valve to enable it to be opened and closed.

In the event that the lower cover 16 is made from a composite material such as carbon fibre reinforced plastic (CFRP), it is necessary to ensure that the maximum temperatures of the probe and the collar are kept well below the delamination temperature of the material (approximately 80° C. for CFRP). It is also necessary, whether the lower cover is made from composite material or not, to ensure that the temperatures of the probe and the collar are kept well below the ignition temperature of the aircraft fuel (which is typically approximately 200° C.). This is because, during the water draining maintenance task, the probe 52 will typically come into contact with at least a small quantity of fuel and any potential ignition risks must be avoided. Typically, a probe heated to approximately 50-55° C. is sufficient to melt the ice crystals around the poppet 32. Therefore, these upper temperature limits do not impose any meaningful practical limitations. In order to ensure that the temperatures of the probe and the collar are kept below these temperatures even in the event of an electrical fault, thermal fuses and/or electrical fuses are coupled to the heating elements.

Additionally or alternatively to the heating elements within the probe and/or the removable collar, a source of heating electromagnetic radiation (such as infrared radiation) may be fitted to the drain tool 90. In this case, a shroud may be installed around the shaft of the probe 62. A source adapted to direct radiation/heat towards the valve is fitted within the shroud. Thus, when the water drain tool is lifted to engage the valve 18, the electromagnetic radiation source (further) heats the valve and surrounding area to help melt any ice which may be interfering with the operation of the valve. The source may be, for example, an incandescent light source or an infrared laser or light emitting diode (LED) source.

Optionally, the tool 90 may be fitted with an air blower 101 which is mounted to the shaft 66 and is adapted to blow air heated by the heat source(s) towards the valve 18. This aids heat transfer both to the valve and to the portion of the lower cover 16 surrounding the valve 18 where ice can also accumulate. Note that the blower 101 may be fitted in any suitable location which allows heated air to be directed towards the water drain valve and/or its surrounding area. For example, the blower 101 may alternatively be mounted on the bottle 74. Additionally or alternatively, the blower 101 may be provided with a flexible hose which enables heated air to be directed to different positions around the valve 18.

An ultrasonic transducer (which would also be coupled to the battery pack 92) may optionally be housed within the probe 62. In this case, when the transducer is activated, the probe 62 vibrates. As the probe 62 engages the poppet 32, the vibration is transferred to the head 36 of the poppet 32. This helps to break up ice formed around the poppet 32, increasing the exposed surface area of the ice, and thus increasing the speed at which the ice can be melted by the heating elements and/or electromagnetic source. For example, but not exclusively, the transducer may vibrate the probe at frequencies of up to 25 MHz. Preferably, the frequency of vibration of the probe is tuned to the resonant frequency of the ice formed around the poppet. However, the resonant frequency of the ice will depend on its thickness. For example, a sheet of ice 0.45 mm thick may have a resonant frequency of approximately 28 kHz. Therefore, the frequency of vibration of the probe is preferably variable along a range of interest so as to be tuneable to the resonant frequencies of varying thicknesses of ice. The combination of the heating elements in the probe (and optionally the removable collar) and/or the electromagnetic source thus provides a powerful tool for removing ice in the water drain valves 18. Note that the amplitude of vibration of the transducer should be limited to avoid damage to the aircraft or gauging systems. Note also that the ultrasonic vibration does not impose an ignition risk.

As an alternative to incorporating an electrical heating element within the removable collar 100, one or more chemical heating packs, such as that disclosed in U.S. Pat. No. 5,205,278, may instead be employed. In this case, such a chemical heating pack will replace the heating element in the collar 100. As described in U.S. Pat. No. 5,205,278, the pack is heated by deforming a metal disc which triggers an exothermic chemical reaction within the pack. The disc may be deformed either before or after the collar 100 has been installed on the funnel 64. The reaction (and therefore the heat source) can last up to three hours. Moreover, the pack can be recharged by placing the pack in hot water (>80° C.). This method is beneficial compared with using a heating element as the removable collar 100 does not need to be connected to the battery pack 92, which simplifies installation procedures. However, it is noted that it remains necessary for the probe to be heated using the heating element and battery pack 92 as before.

It is further noted that, as an alternative to the chemical heating pack described in U.S. Pat. No. 5,205,278, a microwavable heating pack such as the one described in U.S. Pat. No. 4,880,953 may be incorporated into the removable collar 100 in place of a heating element. In this case, the removable collar 100 comprising the heat pack would be heated (for example in a microwave oven) prior to its installation on the funnel 64.

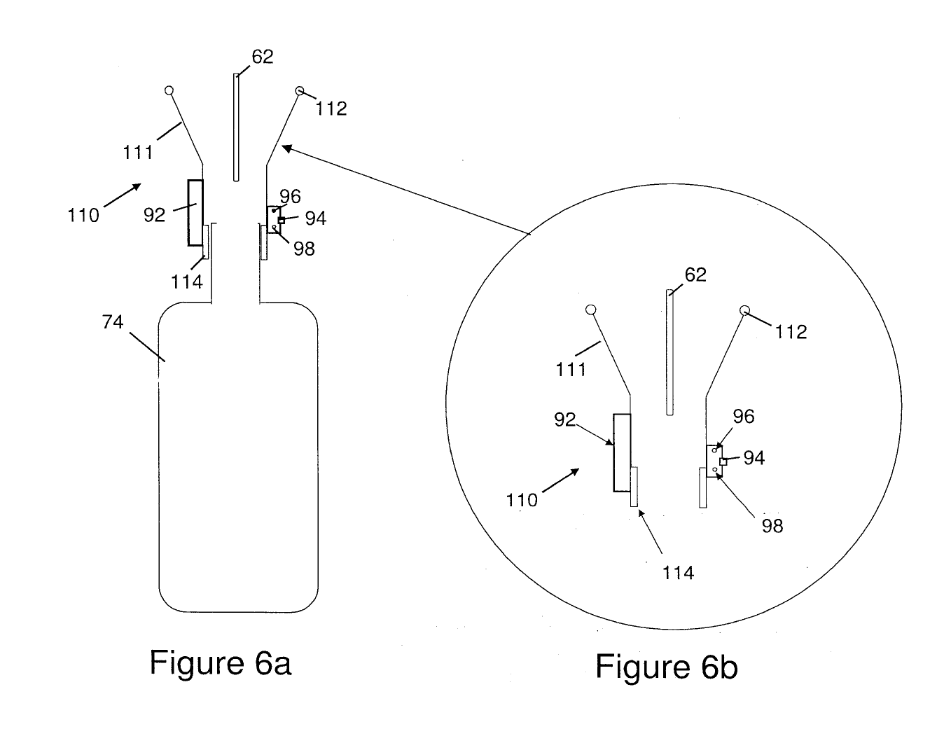

FIGS. 6a-6b show an alternative water drain tool 110 to the tool 90 described above. The tool 110 is similar to the tool 90 and identical features will be given the same reference numerals. The probe 62 is mounted in a funnel 111 and the probe 62 has an electrically resistive heating element (which is coupled to the battery pack 92) embedded within it as before. However, in this case, the battery pack 92, the on/off switch 94, charge indicator 96 and on/off indicator 98 are mounted to the outer surface of the funnel 111, rather than the bottle 74. Additionally, rather than employing a removable collar 100, the lip 112 of the funnel 111 is embedded with an electrically resistive heating element. Furthermore, the funnel 111 comprises a threaded neck 114 which allows it to be retrofitted to the bottle 74 of the existing water drain tool 60 described above. The water drain tool 110 can be used in an identical way to the tool 80 described above.

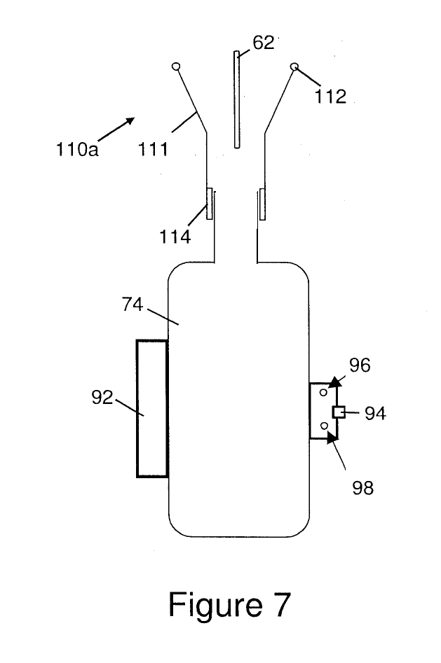

FIG. 7 shows an alternative embodiment 110a of the water drain tool 110 shown in FIGS. 6a-6b. Identical features will be given the same reference numerals. In this case, the battery pack 92, the on/off switch 94, charge indicator 96 and on/off indicator 98 are attached to the outer surface of the bottle 74. However, the funnel 111 is again provided with a heating element embedded within its lip 112, removing the need for the removable collar 100.

Although the invention has been described above with reference to one or more preferred embodiments, it will be appreciated that various changes or modifications may be made without departing from the scope of the invention as defined in the appended claims.

1. A water drain tool for opening a water drain valve of an aircraft fuel tank, the tool comprising a probe and a heat source, wherein the probe is adapted to engage the valve in order to open it and the heat source is adapted to direct heat towards the valve when the valve is being opened.

2. The water drain tool of claim 1 wherein the heat source is housed within the probe.

3. The water drain tool of claim 1 further comprising a funnel.

4. The water drain tool of claim 3 wherein the probe is disposed within the funnel.

5. The water drain tool of claim 1 wherein the heat source is housed within the funnel.

6. The water drain tool of claim 1 wherein the heat source comprises a removable heated collar.

7. The water drain tool of claim 1 wherein the heat source comprises an electrically resistive heating element.

8. The water drain tool of claim 1 wherein the heat source further comprises an air blower.

9. The water drain tool of claim 1 wherein the heat source comprises a thermal fuse.

10. The water drain tool of claim 1 wherein the tool includes a battery power source.

11. The water drain tool of claim 1 wherein the tool comprises a vibrating means for vibrating the probe.

12. The water drain tool of claim 1 further comprising a container for collecting fluid.

13. A method of opening a water drain valve of an aircraft fuel tank using a water drain tool, the tool comprising a probe and a heat source, the method comprising: engaging the valve with the probe; and directing heat towards the valve from the heat source.

14. The method of claim 13 further comprising applying pressure to the probe in order to open the valve.

15. The method of claim 14 further comprising lifting a poppet of the valve with the probe in order to open the valve.

16. The method of claim 13 further comprising directing heat towards the valve through the probe.

17. The method of claim 13 further comprising vibrating the probe.

18. The method of claim 13 further comprising: draining fluid from the fuel tank; and collecting the fluid in a container.

19. The method of claim 13 using a water drain tool comprising a probe and a heat source, wherein the probe is adapted to engage the valve in order to open it and the heat source is adapted to direct heat towards the valve when the valve is being opened.
